(19) United States
(12) Patent Application Publication
(10) Pub. No.: US 2025/0158041 A1
(43) Pub. Date: May 15, 2025

(54) ANODE MATERIAL, PREPARATION METHOD THEREOF AND LITHIUM ION BATTERY

(71) Applicants: BTR NEW MATERIAL GROUP CO., LTD., Shenzhen (CN); DINGYUAN NEW ENERGY TECHNOLOGY CO., LTD., Huizhou (CN)

(72) Inventors: Wei XIE, Shenzhen (CN); Chunlei PANG, Shenzhen (CN); Zhiqiang DENG, Shenzhen (CN); Jianguo REN, Shenzhen (CN); Xueqin HE, Shenzhen (CN)

(73) Assignees: BTR NEW MATERIAL GROUP CO., LTD., Shenzhen (CN); DINGYUAN NEW ENERGY TECHNOLOGY CO., LTD., Huizhou (CN)

(21) Appl. No.: 19/020,738

(22) Filed: Jan. 14, 2025

Related U.S. Application Data
(63) Continuation of application No. PCT/CN2023/118419, filed on Sep. 13, 2023.

(30) Foreign Application Priority Data
Dec. 29, 2022 (CN) 202211711132.6

(51) Int. Cl. H01M 4/36; H01M 4/02; H01M 4/04; H01M 4/38; H01M 4/58; H01M 4/62; H01M 10/0525

(52) U.S. Cl. CPC H01M 4/366; H01M 4/0471; H01M 4/386; H01M 4/5825; H01M 4/625; H01M 10/0525; H01M 2004/021; H01M 2004/027

(57) ABSTRACT

An anode material, a method for preparing the same, and a lithium ion battery. The anode material includes a core and a first coating layer at least partially coating on a surface of the core. The core includes a silicon-based material, the first coating layer comprises a carbon material, and at least a part of a surface of the first coating layer is distributed with a fiber material. The fiber material and the anode material satisfy a formula (I):

$$\frac{{D}_{w i r e}}{{D}_{10}} \times \frac{1}{exp ( ρ ) - 1} \leq 0 \text{.15} , \qquad ( I )$$

in the formula (I), D_{wire} represents a minimum fiber diameter (nm) of the fiber material, D₁₀ represents a corresponding particle size (nm) when the cumulative particle size distribution number of the anode material reaches 10%, and ρ represents a powder conductivity (S/cm) of the anode material.

### CROSS REFERENCES TO RELATED APPLICATIONS

This application is a continuation of International Application No. PCT/CN2023/118419, filed Sep. 13, 2023, which claims priority to Chinese Patent Application No. 202211711132.6, filed Dec. 29, 2022 the entire disclosures of which are hereby incorporated by reference in their entirety.

### TECHNICAL FIELD

The present disclosure belongs to the technical field of anode materials, and particularly relates to an anode material, a method for preparing the anode material, and a lithium ion battery.

### BACKGROUND

Silicon-based anode materials are one of the most key materials for high energy density lithium ion batteries, while existing silicon-based materials have problems such as large expansion and poor rate, which affects the wide application of silicon-based anode materials in lithium batteries. Therefore, inhibiting expansion and improving the cycle rate performance of silicon-based materials is a premise that silicon-based materials can be widely used.

In the process of designing and improving the silicon-based anode material, the design of the material structure is critical for improving the performance of the silicon-based anode material. In the related art, an anode material mainly composed of nano-silicon wires is usually used to prepare a thin film battery. For an anode material of a lithium ion battery, the anode material generally needs to be processed into a powder or granular structure, and the structure of the nano silicon wires cannot be applied, resulting in limited improvement of the conductivity of the material, and further resulting in limited improvement of the rate performance of the anode material. In addition, the existing anode material improves the cycle performance of the material by forming an SEI, but the SEI is generally formed of an insulating material, and the use of the insulating material also causes the rate performance of the material to be reduced.

Therefore, there is an urgent need to improve existing silicon-based anode materials to improve the rate performance of the materials.

### SUMMARY

The present disclosure provides an anode material, a method for preparing the anode material and a lithium ion battery, which can improve the rate performance of the anode material.

According to a first aspect, an embodiment of the present disclosure provides an anode material, the anode material includes a core and a first coating layer at least partially coating on a surface of the core. The core includes a silicon-based material, the first coating layer includes a carbon material, and at least a part of a surface of the first coating layer is distributed with a fiber material.

The fiber material and the anode material satisfy the formula (I):

$$\frac{{D}_{w i r e}}{{D}_{10}} \times \frac{1}{exp ( ρ ) - 1} \leq 0.15 \qquad ( I )$$

In formula (I), D_{wire} represents a minimum fiber diameter (nm) of the fiber material, D₁₀ represents a corresponding particle size (nm) when the cumulative particle size distribution number of the anode material reaches 10%, and ρ represents a powder conductivity (S/cm) of the anode material.

With reference to the first aspect, in some embodiments, the anode material includes at least one of following features (1) to (7):
(1) a fiber diameter of the fiber material ranges from 2 nm to 200 nm;
(2) interior of the first coating layer is distributed with the fiber material;
(3) the fiber material includes at least one of carbon fiber and silicon fiber;
(4) the fiber material includes at least one of carbon fiber and silicon fiber, and the carbon fiber includes at least one of carbon fiber, carbon nanotube and polymer fiber;
(5) the fiber material includes at least one of carbon fiber and silicon fiber, and the silicon fiber includes at least one of silicon fiber and silicate fiber;
(6) the fiber material includes at least one of carbon fiber and silicon fiber, the carbon fiber includes at least one of carbon fiber, carbon nanotube and polymer fiber, and the polymer fiber includes at least one of polypropylene fiber, polyester fiber, polyamide fiber, polyacrylic fiber, polymerase fiber and polyamine fiber; and
(7) the carbon material includes at least one of amorphous carbon, graphite, graphene, and diamond-like carbon.

With reference to the first aspect, in some embodiments, the anode material includes at least one of following features (1) to (4):
(1) the first coating layer further includes a salt substance and the salt substance includes an inorganic salt and an organic salt;
(2) the first coating layer further includes a salt substance, the salt substance includes an inorganic salt and an organic salt, and the inorganic salt includes at least one of fluoride, lithium salt, carbonate, silicate, phosphate, nitrate, titanate, thioate and vanadate;
(3) the first coating layer may further includes a salt substance, the salt substance includes an inorganic salt and an organic salt, and the organic salt includes at least one of a carboxylate, an alkoxide, and an aromatic salt compound; and
(4) the first coating layer further includes a salt substance, and a thickness of the first coating layer ranges from 0.1 μm to 1.2 μm.

With reference to the first aspect, in some embodiments, the anode material includes at least one of following features (1) to (6):
(1) a thickness of the first coating layer ranges from 0.01 μm to 1 μm;
(2) the first coating layer contains a first doping element, and the first doping element includes at least one of N, P, B, S, O, F, Cl, Br, and I;
(3) the first coating layer contains a first doping element, and a mass ratio of the first doping element in the first coating layer ranges from 0.01% to 5%;
(4) the core includes at least one of crystalline silicon and silicide;
(5) the core includes at least one of crystalline silicon and a silicide, the silicide includes at least one of silicate, silicon oxide, silicon phosphide, silicon carbide, silicon nitride, and silicon alloy; and
(6) a mass ratio of the metal element in the core ranges from 0 to 15%, and the metal element includes at least one of lithium, sodium, magnesium, aluminum, copper, titanium, boron, beryllium, calcium, vanadium, chromium, lanthanum and selenium.

With reference to the first aspect, in some embodiments, the anode material further includes a second coating layer disposed between the core and the first coating layer and/or a second coating layer disposed on a region of the core surface that is not coated by the first coating layer.

With reference to the first aspect, in some embodiments, the second coating layer includes at least one of following features (1) to (5):
(1) the second coating layer includes a salt substance, and the salt substance includes an inorganic salt and an organic salt;
(2) the second coating layer includes a salt substance, the salt substance includes an inorganic salt and an organic salt, and the inorganic salt includes at least one of fluoride, lithium salt, carbonate, silicate, phosphate, nitrate, titanate, thioate and vanadate;
(3) the second coating layer includes a salt substance, the salt substance includes an inorganic salt and an organic salt, and the organic salt includes at least one of a carboxylate, an alkoxide, and an aromatic salt compound;
(4) the second coating layer includes a salt substance, and a mass ratio of the salt substance in the anode material ranges from 0.01 wt % to 3.0 wt %; and
(5) a thickness of the second coating layer ranges from 0 μm to 1 μm.

With reference to the first aspect, in some embodiments, the anode material includes at least one of following features (1) to (7):
(1) the anode material includes a salt substance, and a mass ratio of the salt substance ranges from 0 wt % to 3.0 wt %;
(2) a mass ratio of the carbon element in the anode material ranges from 0.5 wt % to 10 wt %;
(3) a median particle size D50 of the anode material ranges from 2.0 μm to 10.0 μm;
(4) a particle size D10 with a particle cumulative distribution of 10% in the anode material ranges from 0.5 μm to 4 μm;
(5) a powder conductivity of the anode material ranges from 0.01 S/cm to 500 S/cm;
(6) a ratio Si/O of silicon to oxygen in the anode material ranges from 0.5 to 3.0; and
(7) a porosity of the anode material ranges from 0.5% to 15%.

In a second aspect, an embodiment of the present disclosure provides a method for preparing an anode material, including following steps:

performing a first heat treatment on a mixture containing a silicon-oxygen raw material and at least two salt substances to form a molten salt to obtain a first precursor; and

mixing the first precursor with a carbon source and then performing a second heat treatment to obtain an anode material.

With reference to the second aspect, in some embodiments, the mixture containing a silicon-oxygen raw material and at least two salt substances further includes a metal source.

With reference to the second aspect, in some embodiments, the method includes at least one of following features (1) to (3):
(1) the metal source includes at least one of lithium metal, magnesium metal, sodium metal, calcium metal, copper metal and titanium metal;
(2) the metal source includes an active hydride formed by at least one of a lithium source, a magnesium source, a sodium source, a calcium source, a copper source and a titanium source; and
(3) a mass ratio of the metal source in the first precursor ranges from 0 wt % to 15 wt %.

With reference to the second aspect, in some embodiments, the method includes at least one of following features (1) to (10):
(1) the silicon-oxygen raw material includes silicon oxide SiOx, where 0.05≤x≤2;
(2) the salt substance includes an inorganic salt and an organic salt;
(3) the salt substance includes an inorganic salt and an organic salt, and the inorganic salt includes at least one of fluoride, lithium salt, carbonate, silicate, phosphate, nitrate, titanate, thioate and vanadate;
(4) the salt substance includes an inorganic salt and an organic salt, and the organic salt includes at least one of a carboxylate, an alkoxide and an aromatic salt compound;
(5) a mass ratio of the salt substance in the first precursor ranges from 1.0 wt % to 20 wt %;
(6) a temperature of the first heat treatment ranges from 400° C. to 1200° C.;
(7) a heat preservation time of the first heat treatment ranges from 3 h to 24 h;
(8) a heating rate of the first heat treatment ranges from 1° C./min to 10° C./min;
(9) a pressure of the first heat treatment ranges from 0.1 MPa to 20 MPa; and
(10) the first heat treatment is performed in a first protective atmosphere, the first protective atmosphere includes at least one of nitrogen, helium, and argon.

With reference to the second aspect, in some embodiments, the method includes at least one of following features (1) to (6):
(1) the carbon source includes at least one of a solid carbon source and a gaseous carbon source;
(2) the carbon source includes at least one of a solid carbon source and a gaseous carbon source, and the solid carbon source includes at least one of asphalt, epoxy resin and phenolic resin;
(3) the carbon source includes at least one of a solid carbon source and a gaseous carbon source, and the gaseous carbon source includes at least one of methane, acetylene, ethylene and propane;
(4) the carbon source includes a gaseous carbon source, and an injection flow rate of the gaseous carbon source ranges from 0.5 L/min to 3 L/min;
(5) the carbon source includes a solid carbon source, and a mass ratio of the first precursor to the carbon source is 1:(0.01 to 0.1); and
(6) the carbon source includes a solid carbon source, the second heat treatment is performed in a second protective atmosphere, the second protective atmosphere includes at least one of nitrogen, helium, and argon.

With reference to the second aspect, in some embodiments, the method includes at least one of following features (1) to (3):
(1) a temperature of the second heat treatment ranges from 400° C. to 1000° C.;
(2) a heat preservation time of the second heat treatment ranges from 0.5 h to 10 h; and
(3) a heating rate of the second heat treatment ranges from 1° C./min to 10° C./min.

With reference to the second aspect, in some embodiments, after the second heat treatment, the method further includes: a step of washing and drying the material obtained by the second heat treatment with water.

With reference to the second aspect, in some embodiments, the method includes at least one of following features (1) to (5):
(1) the water washing time ranges from 30 min to 90 min;
(2) the water washing flow rate ranges from 5 L/min to 20 L/min;
(3) the drying method includes at least one of blast drying and vacuum drying;
(4) the drying temperature ranges from 25° C. to 120° C.; and
(5) the drying time ranges from 3 h to 48 h.

With reference to the second aspect, in some embodiments, before washing the material obtained by the second heat treatment with water, the method further includes: a step of soaking and filtering the material obtained by the second heat treatment in water.

With reference to the second aspect, in some embodiments, the method includes at least one of following features (1) to (3):
(1) the soaking time ranges from 10 min to 60 min;
(2) the soaking is performed under a stirring condition at a stirring speed of 100 r/min to 500 r/min; and
(3) the soaking is performed under the stirring conditions, and the soaking temperature ranges from 25° C. to 80° C.

According to a third aspect, an embodiment of the present disclosure provides a lithium ion battery, the lithium ion battery includes the anode material according to the first aspect or the anode material prepared by the method according to the second aspect.

The technical solution of the present disclosure has at least following beneficial effects.

In the anode material of the present disclosure, the fiber material is coated on the surface of the first coating layer, and the fiber material and the anode material meet the formula (I), indicating that the fiber material of the anode material grows well in the radial direction. The fiber material growing well in the radial direction can effectively reduce the load transfer impedance caused by lithium intercalation, improve the mass transfer efficiency, form a rapid lithium intercalation channel, facilitate the in-situ conduction of the anode material and the lithium source, reduce the interface obstruction, so that the lithium conduction capability of the anode material is improved, and the anode material can quickly receive electrons and lithium ions, thereby improving the conductivity of the anode material, and further improving the cycle performance and the rate performance of the anode material. Further, the anode material is of a core-shell structure, and the shell includes a coating layer containing a carbon material, the conductive contact area of the anode material can be improved, and the rate performance of the anode material is further improved.

In the present disclosure, a mixture containing a silicon-oxygen raw material and at least two salt substances is subjected to first heat treatment, the salt substances can form a liquid mixed salt-molten salt system, a first precursor and a carbon source are mixed and then subjected to second heat treatment, a carbon layer formed by the carbon source coats the surface of the silicon-oxygen raw material, so that the conductive contact area of the anode material can be improved, thereby improving the conductivity. Further, a part of carbon and/or silicon element grows into a fiber material under the catalysis of the mixed salt molten salt system and extends to the surface of the carbon layer, and the presence of fibers on the surface of the carbon layer can improve the mass transfer capacity and load transfer capacity of the anode material, so that the rate performance and the first efficiency of the anode material are improved. The preparation process of the present disclosure is simple and suitable for large-scale industrialization.

### BRIEF DESCRIPTION OF DRAWINGS

The present disclosure is further described below with reference to the accompanying drawings and Examples.

FIG. 1 is a structural schematic diagram of an anode material of the present disclosure in which the coating layer is a single-layer structure;

FIG. 2 is a structural schematic diagram of a composite layer formed by a carbon material and a salt material in a first coating layer of an anode material of the present disclosure;

FIG. 3 is a structural schematic diagram of an anode material having a double-layer coating layer according to the present disclosure;

FIG. 4 is a flowchart of preparing an anode material according to the present disclosure;

FIGS. 5A-5F are a comparison diagrams of surface SEM images of Example 1 (FIG. 5A), Example 2 (FIG. 5B), Example 3 (FIG. 5C), Comparative Example 1 (FIG. 5D), Comparative Example 2 (FIG. 5E), and Comparative Example 3 (FIG. 5F) of the present disclosure;

FIG. 6 is a comparison diagram of low-temperature capacity test performance of a full battery prepared from the anode materials of Examples 1 to 8 of the present disclosure and Comparative Examples 1 to 4;

FIGS. 7A-7B show an EDS test diagram of Example 2 of the present disclosure; and

FIGS. 8A-8B show an EDS test diagram of Comparative Example 4 of the present disclosure.

### DESCRIPTION OF EMBODIMENTS

In order to better understand technical solutions of the present disclosure, the embodiments of the present disclosure are described in details with reference to the drawings.

It is to be made clear that the described embodiments are only some rather than all of the embodiments of the present disclosure. All other embodiments obtained by those of ordinary skill in the art based on the embodiments in the present disclosure fall within the protection scope of the present disclosure.

The terms used in the embodiments of the present disclosure are only for the purpose of describing specific embodiments, and are not intended to limit the present disclosure. The singular forms of “a”, “the” and “this” used in the embodiments of the present disclosure and the appended claims are also intended to include the plurality form, unless the context clearly indicates other meanings.

It should be understood that the term “and/or” used herein is merely an association relationship describing an associated object, and indicates that there can be three relationships, for example, A and/or B, and can indicate: only A, both A and B, and only B. In addition, the character “/” herein generally means an “or” relationship between the associated objects.

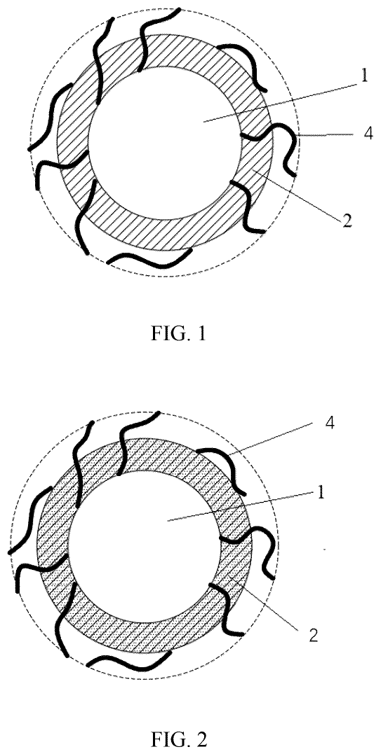

The present disclosure provides an anode material, referring to FIG. 1, the anode material includes a core 1 and a first coating layer 2 at least partially coating on a surface of the core 1, the core 1 includes a silicon-based material, a material of the first coating layer 2 includes a carbon material, and at least a part of a surface of the first coating layer 2 is distributed with a fiber material 4.

The fiber material 4 and the anode material satisfy the formula (I):

$$Δ J = \frac{{D}_{w i r e}}{{D}_{10}} \times \frac{1}{exp ( ρ ) - 1} \leq 0.15 \qquad ( I )$$

In formula (I), D_{wire} is a minimum fiber diameter (nm) of the fiber material 4, D₁₀ is a corresponding particle size (nm) when the cumulative particle size distribution number of the anode material reaches 10%, and ρ is a powder conductivity (S/cm) of the anode material.

In the above solution, in the anode material of the present disclosure, the fiber material 4 is coated on the surface of the first coating layer 2, and the fiber material and the anode material meet the formula (I), indicating that the fiber material 4 of the anode material grows well in the radial direction. The fiber material 4 growing well in the radial direction can effectively reduce the load transfer impedance caused by lithium intercalation, improve the mass transfer efficiency, form a rapid lithium intercalation channel, facilitate the in-situ conduction of the anode material and the lithium source, reduce the interface obstruction, so that the lithium conduction capability of the anode material is improved, and the anode material can quickly receive electrons and lithium ions, thereby improving the conductivity of the anode material, and further improving the cycle performance and the rate performance of the anode material. Further, the anode material is of a core-shell structure, and the shell includes a coating layer containing a carbon material, the conductive contact area of the anode material can be improved, and the rate performance of the anode material is further improved.

In the present disclosure, a value of AJ can be 0.005, 0.008, 0.04, 0.05, 0.08, 0.1, 0.12 or 0.15, or the like, and can also be other values within the above range, which is not limited herein. According to the present disclosure, whether the fiber material 4 can construct the electron ion mass transfer channel is determined based on the minimum fiber diameter D_{wire} of the fiber material 4, the particle size D₁₀ of the anode material and the conductivity p of the anode material. In particular, ΔJ is within the range, it is indicated that the fiber material 4 of the anode material grows well in the radial direction, the fiber material 4 can effectively reduce the load transfer impedance caused by lithium intercalation, improve the mass transfer efficiency, form a rapid lithium intercalation channel, improve the load transfer resistance between the material interfaces, and improve the rate performance and the low temperature performance of the anode material. In addition, compared with the powdered material, the fiber material 4 of the present disclosure has a wider mass transfer and load transfer area and a high extensibility, and can effectively combine the battery conductive network, thereby improving the cycle performance of the anode material. If ΔJ is greater than 0.15, the material would deteriorate. According to the present disclosure, the distribution condition of small particles in the anode material is controlled through D₁₀, and the powder of the small particles has a relatively high specific surface area and can generate relatively strong interaction with the fiber material, so that the radial growth and distribution of the fiber material are influenced, thereby further affecting the electrochemical performance of the anode material.

It can be understood that the diameter of the fiber material 4 in a single anode material can vary greatly, for D_{wire} in the present disclosure, the minimum diameter of the fiber in the measurable sample is taken for substitution calculation, and the minimum diameter of the fiber in the sample is tested with reference to the national standard “GB/T268260-2011 carbon nanotube diameter measurement method”. The fiber diameter (according to the diameter) is quantitatively measured by using an electron microscope SEM/TEM, and the point resolution ratio is better than 0.3 nm. Firstly, a sample is prepared, electron microscope shooting is carried out, a certain number of TEM/SEM effective view field images need to be obtained, then all effective view field images are analyzed, the fiber diameter is measured and counted, finally, a fiber sample diameter distribution diagram is drawn, the average diameter and the standard deviation are calculated, and a limit value is taken as D_{wire}. It should be noted that selecting a representative effective field of view with no smaller than 10 TEM/SEM images requires that the total number of fibers with measurable diameter in one TEM/SEM image exceeds 200. According to the present disclosure, TEM/SEM measurement analysis is performed on a sample, diameter data of all fibers with identifiable diameters in an image is measured and recorded, and a specific measurement method is as follows: a straight line is made perpendicular to the axial direction of the fiber, the outer diameters are measured respectively, and the measurement result needs to be converted into an actual scale of the fiber diameter according to the TEM/SEM image mark.

Regarding the result calculation, for one anode material powder sample, the fiber diameter distribution is counted and expressed as a fiber fraction column histogram form, one column identifier in the histogram represents the fiber fraction distributed in the interval, that is, the percentage of the fiber number with a diameter within a certain range in the total number of the counted fibers, and the width of the interval of the histogram is the distance between the centers of adjacent columns, and the value of the interval can be determined according to actual requirements. In the present disclosure, the granularity range is divided into 10 intervals for statistical diameter distribution. Finally, according to the above diameter measurement data, the average diameter and standard deviation are calculated according to

$$d = \frac{{\sum }_{i = 1}^{n} {d}_{i}}{n} \qquad formula ( 1 )$$

$$and$$

$$σ = \sqrt{\frac{{\sum }_{i = 1}^{n} {( {d}_{i} - d )}^{2}}{n = 1}} , \qquad formula ( 2 )$$

and the limit value is adopted, that is, the value of D_{wire} in the present disclosure.

In some embodiments, when the amount of the fiber material 4 on the surface of the first coating layer 2 is relatively small, the fiber material 4 is dispersed and distributed on the surface of the first coating layer 2, and when the amount of the fiber material 4 on the surface of the first coating layer 2 is relatively large, the fiber material 4 can serve as a coating layer to cover the surface of the first coating layer 2 (the coating layer used is shown by a dashed line in FIG. 1).

In some embodiments, referring to FIG. 1, interior of the first coating layer 2 is distributed with a fiber material 4. It can be understood that, in an embodiment, interior and the surface of the first coating layer 2 are distributed with the fiber material 4, that is, the fiber material 4 penetrates through the first coating layer 2 and is distributed on the surface of the first coating layer 2, and the fiber material 4 can form a rapid lithium-embedding channel between the surface of the core 1 and the surface of the anode material, thereby greatly improving the ion and electron transport performance of the anode material.

In some embodiments, the fiber material 4 includes at least one of carbon-based fiber and silicon-based fiber.

In some embodiments, the carbon-based fiber includes at least one of carbon fiber, carbon nanotube, and polymer fiber. The polymer fiber includes at least one of polypropylene fiber, polyester fiber, polyamide fiber, polyacrylic fiber, polypolymerase fiber, and polyamine fiber. For example, the polymer fiber includes at least one of polyethylene oxide fiber, polyacrylonitrile fiber, polyvinylidene fluoride fiber, polymethyl methacrylate fiber, polypropylene oxide fiber, and polyvinylidene chloride fiber.

In some embodiments, the silicon-based fiber includes at least one of silicon fiber and silicate fiber.

In the present disclosure, compared with the silicon fiber, the carbon fiber has the smallest fiber diameter, the morphology of the carbon fiber is slender, and the carbon fiber is bent. The diameter of the silicon fiber is relatively large, the fiber diameter of the silicon fiber is medium, the fiber diameter of the silicate is maximum, and the silicon fiber and the silicate fiber are basically upright without bending, so that the anode material can perform SEM/EDS testing, and can be differed according to the fiber diameter and morphology. The anode material is also possible to differ by element composition. It should be understood that the thickness of the fiber material 4 in FIG. 1 is merely illustrative and does not represent the actual diameter distribution of the fiber material 4. In FIG. 1 to FIG. 3, 1—core, 2—first coating layer, 3—second coating layer; and 4—fiber material.

In some embodiments, the fiber diameter of the fiber material 4 ranges from 2 nm to 200 nm, the fiber diameter of the fiber material 4 can be 2 nm, 5 nm, 10 nm, 30 nm, 50 nm, 80 nm, 100 nm, 150 nm, 180 nm, or 200 nm, or the like, and can also be other values within the above range, which is not limited herein. If the fiber diameter of the fiber material 4 is greater than 200 nm, a block structure would appear on the surface of the material, which results an increase in the mass transfer resistance of the material. If the fiber diameter of the fiber material 4 is smaller than 2 nm, the influence range of the fiber material 4 is too small, and the fiber ratio needs to be increased to behave high mass transfer performance and load transfer performance, but the material capacity is reduced.

In some embodiments, the carbon material includes at least one of amorphous carbon, graphite, graphene, and diamond-like carbon (DLC), the diamond-like carbon is also referred to as adamas-like carbon, and mainly includes a large amount of sp³ hybrid amorphous carbon, and further includes a small amount of diamond crystallites and graphite crystallites.

In some embodiments, the material of the first coating layer 2 further includes a salt substance. Referring to FIG. 2, which is a structural schematic diagram of an anode material in which the first coating layer 2 includes a carbon material and a salt substance. The carbon material can further improve the electrical conductivity of the material, the salt substance has excellent chemical stability, compactness and easy adhesion, and can form a rigid skeleton in the first coating layer 2, which can improve the structural stability of the anode material, and the rigid skeleton can facilitate SEI deposition to form a rigid layer, thereby stabilizing the SEI interface and inhibiting irreversible expansion of the material, thereby improving the cycle capacity retention rate and cycle performance of the anode material. In this embodiment, the combination of the coating layer that includes the carbon material and the salt substance with the fiber material 4 can improve the rate performance and capacity of the anode material and inhibit irreversible expansion of the anode material.

In some embodiments, the salt substance includes an inorganic salt and an organic salt.

In some embodiments, the inorganic salt includes at least one of fluoride, lithium salt, carbonate, silicate, phosphate, nitrate, titanate, thioate, and vanadate. For example, the inorganic salt includes lithium fluoride, lithium thiophosphate, lithium vanadate, lithium titanate, lithium carbonate, lithium phosphate, lithium silicate, lithium nitrate, aluminum fluoride, aluminum carbonate, sodium carbonate, potassium carbonate, magnesium carbonate, calcium carbonate, sodium lithium carbonate, potassium lithium carbonate, potassium fluoride, sodium fluoride, lithium hexafluorophosphate, lithium tetrafluoroborate, and lithium hexafluoroarsenate, or the like.

The organic salt includes at least one of a carboxylate, an alkoxide, and an aromatic salt compound. For example, the organic salt includes lithium acetate, aluminum formate, magnesium acetate, aluminum isopropoxide, magnesium ethoxide, and lithium benzenesulfonate, or the like.

In some embodiments, the first coating layer 2 includes a first doping element, and the first doping element includes at least one of N, P, B, S, O, F, Cl, Br, and I. It can be understood that the presence of the first doping element stabilizes the SEI interface and inhibits irreversible expansion of the material.

In some embodiments, the mass ratio of the first doping element in the first coating layer 2 ranges from 0.01% to 5%, e.g., the mass ratio of the first doping element in the first coating layer 2 can be 0.01%, 0.05%, 0.1%, 0.5%, 1%, 2%, 3%, 4% and 5%, or the like, and can also be other values within the above range, which is not limited herein.

In some embodiments, the material of the core 1 includes crystalline silicon and silicide. In some embodiments, the silicide includes at least one of silicate, silicon oxide, silicon phosphide, silicon carbide, silicon nitride, and silicon alloy.

In the present disclosure, the silicon oxide is a silicon-oxygen composite including oxygen atoms and silicon atoms, and the molar ratio of oxygen atoms to silicon atoms ranges from 0.5 to 2. The general formula is represented as SiOₓ (0.5≤x≤2), which can be a material formed by dispersing silicon particles in SiO₂, or a material having a tetrahedral structural unit in which silicon atoms are located at the center of the tetrahedral structural unit, and silicon atoms and oxygen atoms are located at four vertices of the tetrahedral structural unit.

In some embodiments, the mass ratio of the metal element in the core 1 ranges from 0% to 15%. The metal element includes at least one of lithium, sodium, magnesium, aluminum, copper, titanium, boron, beryllium, calcium, vanadium, chromium, lanthanum, and selenium. For example, the mass ratio of the metal element in the core 1 can be 0%, 3%, 5%, 8%, 10%, 12% and 15%, or the like, and can be other values within the above range, which is not limited herein.

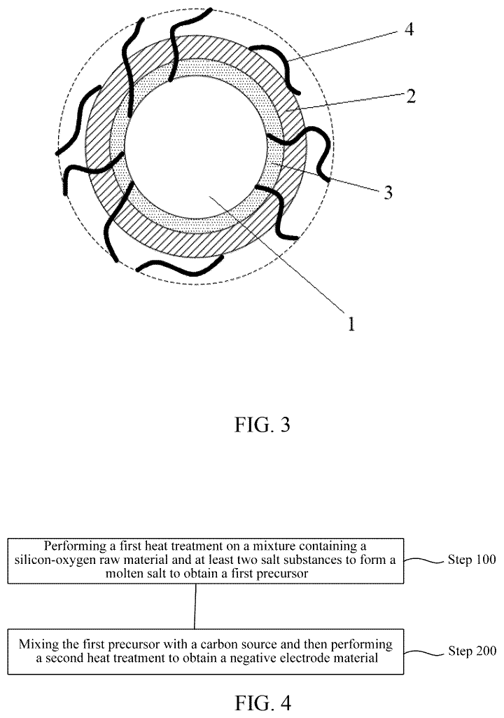

In some embodiments, referring to FIG. 3, the anode material further includes a second coating layer 3 disposed between the core 1 and the first coating layer 2. A material of the second coating layer 3 includes a salt substance, that is, the coating layer of the present disclosure can also be a structure of a double-layer coating layer formed by the second coating layer 3 and the first coating layer 2 sequentially coating the surface of the core 1. The salt substance in the second coating layer 3 is mainly used as a fiber auxiliary agent and has an effect of regulating and controlling the growth of the fiber material, including an effect of regulating and controlling the density and the length and the diameter of the fiber material as crystal nuclei. By regulating and controlling (length and diameter) the fiber material, a three-dimensional reticular mass transfer system is constructed, and a high-density reticular fast ion transmission channel is constructed, the ion transmission efficiency of the anode material at low temperature can be greatly improved, the ion diffusion path is reduced, low-temperature fast conduction of ions is achieved, and the rate and low-temperature performance of the anode material are improved. In some embodiments, when the salt substance is inorganic salt, the inorganic product in the SEI layer formed on the surface of the anode material is regulated and controlled in the cycle process of the prepared battery, the interface of the SEI layer is stabilized, and the cycle performance of the material is improved.

In some embodiments, a second coating layer 3 is disposed on a region of the anode material where the core surface is not coated by the first coating layer 2.

In some embodiments, the fibrous material 4 is also distributed in the second coating layer 3.

In some embodiments, when the first coating layer 2 is a carbon layer, the thickness of the first coating layer 2 ranges from 0.01 μm to 1 μm. In some embodiments, the thickness of the first coating layer 2 can be, for example, 0.01 μm, 0.05 μm, 0.1 μm, 0.2 μm, 0.3 μm, 0.4 μm, 0.5 μm, 0.6 μm, 0.7 μm, 0.8 μm, 0.9 μm or 1 μm, or the like, and can also be other values within the above range, which is not limited herein. In some embodiments, the thickness of the first coating layer 2 ranges from 0.1 μm to 0.5 μm.

In some embodiments, when the first coating layer 2 is a composite coating layer containing a carbon material and a salt substance, the thickness of the first coating layer 2 ranges from 0.1 μm to 1.2 μm. In some embodiments, the thickness of the first coating layer 2 can be, for example, 0.1 μm, 0.2 μm, 0.3 μm, 0.4 μm, 0.5 μm, 0.6 μm, 0.7 μm, 0.8 μm, 0.9 μm, 1 μm and 1.2 μm, or the like, and can also be other values within the above range, which is not limited herein.

In some embodiments, the thickness of the second coating layer 3 ranges from 0 μm to 1 μm. In some embodiments, the thickness of the second coating layer 3 can be, for example, 0 μm, 0.05 μm, 0.1 μm, 0.2 μm, 0.3 μm, 0.4 μm, 0.5 μm, 0.6 μm, 0.7 μm, 0.8 μm, 0.9 μm and 1 μm, or the like, and can also be other values within the above range, which is not limited herein. In some embodiments, the thickness of the second coating layer 3 ranges from 0.05 μm to 0.2 μm.

In some embodiments, the mass ratio of the salt substance in the anode material ranges from Owt % to 3.0 wt %, e.g., a mass ratio of the salt substance in the anode material can be 0 wt %, 0.5 wt %, 1.0 wt %, 1.5 wt %, 2.0 wt %, 2.5 wt % and 3.0 wt %, or the like, and can also be other values within the above range, which is not limited herein.

In some embodiments, the mass ratio of the carbon element in the anode material ranges from 0.5 wt % to 10 wt %, e.g., a mass ratio of the carbon element in the anode material can be 0.5 wt %, 1 wt %, 3 wt %, 5 wt %, 7 wt %, 9 wt % or 10 wt %, or the like, and can also be other values within the above range, which is not limited herein. In some embodiments, the mass ratio of the carbon element in the anode material ranges from 2.5 wt % to 6 wt %.

In some embodiments, the median particle size D₅₀ of the anode material ranges from 2.0 μm to 10.0 μm. In some embodiments, a median particle diameter of the anode material can be 2.0 μm, 3.0 μm, 4.0 μm, 5.0 μm, 6.0 μm, 7.0 μm, 8.0 μm, 9.0 μm or 10.0 μm, or the like, and can also be other values within the above range, which is not limited herein. In some embodiments, the median particle size of the anode material ranges from 4.0 μm to 8.0 μm.

In some embodiments, the particle size D₁₀ with a cumulative distribution of 10% in the anode material ranges from 0.5 μm to 4 μm. In some embodiments, the D₁₀ of the anode material can be 0.5 μm, 1 μm, 2 μm, 3 μm, or 4 μm, or the like, and can also be other values within the above range, which is not limited herein.

In some embodiments, the powder conductivity of the anode material ranges from 0.01 S/cm to 500 S/cm, e.g., the powder conductivity of the anode material can be 0.01 S/cm, 0.1 S/cm, 1 S/cm, 5 S/cm, 10 S/cm, 30 S/cm, 50 S/cm, 100 S/cm, 150 S/cm, 200 S/cm, 300 S/cm, 400 S/cm, or 500 S/cm, or the like, and can also be other values within the above range, which is not limited herein.

In some embodiments, the ratio of silicon to oxygen Si/O in the anode material ranges from 0.5 to 3.0, e.g., a ratio of silicon to oxygen Si/O in the anode material can be 0.5, 1.0, 1.5, 2.0, 2.5 or 3.0, or the like, and can also be other values within the above range, which is not limited herein.

In some embodiments, the porosity of the anode material ranges from 0.5% to 15%, e.g., the porosity of the anode material can be 0.5%, 1%, 3%, 5%, 8%, 10%, 12% or 15%, or the like, and can also be other values within the above range, which is not limited herein. It can be understood that due to the presence of the fiber material 4, certain pores present between the core 1 and the coating layer and inside the coating layer, which can improve the anti-swelling capability of the anode material to some extent.

Referring to FIG. 4, the present disclosure further provides a method for preparing an anode material. The method includes following steps:

performing a first heat treatment on a mixture containing a silicon-oxygen raw material and at least two salt substances to form a molten salt to obtain a first precursor; and

mixing the first precursor with a carbon source and then performing a second heat treatment to obtain an anode material.

According to the above scheme, the mixture containing the silicon-oxygen raw material and at least two salt substances is subjected to the first heat treatment under the sealing condition, the pressure in the sealing condition is increased along with heating treatment of the first heat treatment, the salt substances can form a liquid mixed salt molten salt system, the first precursor and the carbon source are mixed and then subjected to the second heat treatment, the carbon source forms the carbon layer and coats the surface of the silicon-oxygen raw material, the conductive contact area of the anode material can be improved, and the conductivity is improved. In addition, a part of carbon grows into a carbon fiber under the catalysis of the mixed salt molten salt system and extends to the surface of the carbon layer, and the presence of fibers on the surface of the carbon layer can improve the mass transfer capacity of the anode material, so that the rate performance and the first efficiency of the anode material are improved. The preparation process is simple and suitable for large-scale industrialization.

The preparation method of the present disclosure is described below with reference to the embodiments.

Step S100, a first heat treatment is performed on a mixture containing a silicon-oxygen raw material and at least two salt substances to form a molten salt to obtain a first precursor.

In particular, the silicon-oxygen raw material and at least two salt substances are mixed to obtain a mixture, and the first heat treatment is performed on the mixture to obtain a first precursor.

In this step, with the heat treatment of the first heat treatment, at least two salt substances can form a liquid-state mixed salt molten salt system, the liquid-state mixed salt molten salt system further forms a molten salt coating the surface of the silicon-oxygen material under the first heat treatment condition to form a uniformly coated framework layer, and the framework coating layer can facilitate SEI deposition to form a rigid layer, thereby stabilizing the SEI interface and inhibiting irreversible expansion of the material and improving the cycle capacity retention rate and cycle performance of the anode material. It can be understood that the molten salt can be distributed between the silicon-oxygen raw material and the carbon layer to form the second coating layer 3, and/or the molten salt is distributed in the carbon layer to form the composite coating layer. Finally, in the first heat treatment process, a part of the salt substance can enter the core 1 to form doping, thereby improving the conductivity of the material.

In some embodiments, the first heat treatment is performed under the sealing condition, and under the sealing environment, with the heating treatment of the first heat treatment, the pressure in the sealing environment is increased, which is beneficial to the formation of molten salt, and the selectivity of salt substances is enlarged, and some salt substances easy to sublimate can also be applied to the present disclosure.

In some embodiments, the silicon-oxygen raw material includes silicon oxide SiOₓ, 0.05≤x≤2. The raw material can further include elemental silicon and silicate. The silicate includes lithium silicate, magnesium silicate, aluminum silicate, or binary silicate (such as lithium aluminum silicate and lithium magnesium silicate), or the like.

In some embodiments, the salt material includes an inorganic salt and an organic salt. The salt substance has excellent chemical stability, compactness and adhesion, can form a rigid framework, and is easy for the SEI layer to adhere to the surface of the material.

In some embodiments, the inorganic salt includes at least one of fluoride, lithium salt, carbonate, silicate, phosphate, nitrate, titanate, thioate, and vanadate, for example, the inorganic salt includes lithium fluoride, lithium thiophosphate, lithium vanadate, lithium titanate, lithium carbonate, lithium phosphate, lithium silicate, lithium nitrate, aluminum fluoride, aluminum carbonate, sodium carbonate, potassium carbonate, magnesium carbonate, calcium carbonate, sodium lithium carbonate, potassium lithium carbonate, potassium fluoride, sodium fluoride, lithium hexafluorophosphate, lithium tetrafluoroborate, or lithium hexafluoroarsenate, or the like.

In some embodiments, the organic salt includes at least one of a carboxylate, an alkoxide, and an aromatic salt compound, e.g., the organic salt includes lithium acetate, aluminum formate, magnesium acetate, aluminum isopropoxide, magnesium ethoxide, and lithium benzenesulfonate, or the like.

In some embodiments, the mass ratio of the salt substance to the first precursor ranges from 1.0 wt % to 20 wt %. In some embodiments, the mass ratio of the salt substance to the first precursor can be, for example, 1 wt %, 5 wt %, 10 wt %, 15 wt % and 20 wt %, or the like, and can also be other values within the above range, which is not limited herein. If the mass ratio of the salt substance to the first precursor is greater than 20 wt %, the capacity of the material is reduced; if the mass ratio of the salt substance to the first precursor is smaller than 1 wt %, a molten salt system is formed too little, and the obtained fiber material 4 is rare or even unavailable.

In some embodiments, the mixing is performed in a protective atmosphere. The protective atmosphere includes at least one of helium and argon.

In some embodiments, the mixing time ranges from 30 min to 360 min, e.g., the mixing time can be 30 min, 60 min, 90 min, 180 min, 210 min, 240 min, 280 min, 300 min, 350 min or 360 min, or the like, and can also be other values within the above range, which is not limited herein.

In some embodiments, the mixing is performed under stirring conditions, and the mixing device can be, for example, a blender or a ball mill.

In some embodiments, the mixture containing the silicon-oxygen raw material and the salt substance further includes a metal source, that is, in step S100, the silicon-oxygen raw material, the metal source and the salt substance are mixed to obtain a mixture, and a first heat treatment is performed on the mixture to obtain a first precursor.

In the process of the first heat treatment, the presence of the mixed salt molten salt system can improve the activity of the doping metal source and the doping depth of the metal source, so that the silicon-oxygen raw material, the molten salt system and the metal source form eutectic activation, and the silicon-oxygen raw material forms silicon fiber (silicon fiber and silicate fiber) under the catalytic action of the doping metal source, thereby improving the conductivity of the anode material and improving the lithium conduction capability of the anode material, so that the anode material can quickly receive electrons and lithium ions, thereby improving the rate performance and the first efficiency of the anode material.

In some embodiments, the metal source includes at least one of lithium metal, magnesium metal, sodium metal, calcium metal, copper metal, and titanium metal. The metal source can further include an active hydride formed by at least one of a lithium source, a magnesium source, a sodium source, a calcium source, a copper source, and a titanium source. In some embodiments, the metal source can be, for example, lithium, magnesium, aluminum, lithium hydride, aluminum hydride, or magnesium hydride, or the like.

In some embodiments, the mass proportion of the metal source in the first precursor ranges from 0 wt % to 15 wt %. In some embodiments, the mass proportion of the metal source in the first precursor can be, for example, 0 wt %, 3 wt %, 5 wt %, 7 wt %, 10 wt %, 12 wt % and 15 wt %, or the like, and can also be other values within the above range, which is not limited herein. The mass ratio of the metal source in the first precursor is greater than 15 wt %, resulting in poor conductivity and reduced capacity of the material.

In some embodiments, a device for the first heat treatment is a high-pressure reactor.

In some embodiments, the temperature of the first heat treatment ranges from 400° C. to 1200° C. In some embodiments, the temperature of the first heat treatment can be, for example, 400° C., 500° C., 600° C., 700° C., 800° C., 900° C., 1000° C., 1100° C. or 1200° C., or the like, and can also be other values within the above range, which is not limited herein. In the above temperature range of the heat treatment, the capacity and cycle of the material are improved.

In some embodiments, the heat preservation time of the first heat treatment ranges from 3 h to 24 h. In some embodiments, the heat preservation time of the first heat treatment can be, for example, 3 h, 5 h, 8 h, 10 h, 15 h, 18 h, 20 h, 24 h, or the like, and can also be other values within the above range, which is not limited herein.

In some embodiments, the heating rate of the first heat treatment ranges from 1° C./min to 10° C./min. In some embodiments, the heating rate of the first heat treatment can be, for example, 1° C./min, 2° C./min, 3° C./min, 4° C./min, 5° C./min, 6° C./min, 7° C./min, 8° C./min, 9° C./min or 10° C./min, or the like, and can also be other values within the above range, which is not limited herein.

In some embodiments, the pressure of the first heat treatment ranges from 0.1 MPa to 0.3 MPa. In some embodiments, the pressure of the first heat treatment is 0.1 MPa, 0.15 MPa, 0.2 MPa, 0.25 MPa or 0.3 MPa, or the like, and can also be other values within the above range, which is not limited herein.

In some embodiments, the first heat treatment is performed in a first protective atmosphere. The first protective atmosphere includes at least one of nitrogen, helium, and argon.

Step S200, the first precursor is mixed with a carbon source, and then a second heat treatment is performed to obtain an anode material.

In this step, the first precursor and the carbon source are mixed and then subjected to the second heat treatment. Under the catalytic action of the molten salt substance skeleton on the surface of the first precursor, a part of the carbon source generates carbon fiber and grows onto the surface of the material, and the silicon fiber also grow to the surface of the material, that is, the silicon fiber is distributed on the surface of the material, and the carbon fibers are also distributed on the surface of the material. The presence of the fiber material 4 described above improves the electrical conductivity of the anode material and improves the rate performance of the material.

It can be understood that after the first heat treatment and the second heat treatment, a composite coating layer mixed by the salt substance and the coating material can be obtained, or a double-layer coating layer can be obtained. In the double-layer coating layer, the material of the second coating layer 3 in the inner layer includes a salt substance, and the first coating layer 2 in the outer layer includes a carbon material. In addition, when the double-layer coating layer is formed, in the second heat treatment process, a part of the salt-containing substance enters the outer coating layer (i.e., the carbon layer) to form a dopant which can stabilize the SEI interface and inhibit irreversible expansion of the material. The doping elements of the dopant include at least one of N, P, B, S, O, F, Cl, Br, and I.

In some embodiments, the carbon source includes at least one of a solid carbon source and a gaseous carbon source. The solid carbon source includes at least one of asphalt, epoxy resin and phenolic resin. The gaseous carbon source includes at least one of methane, acetylene, ethylene, and propane.

In some embodiments, when the carbon source is a gaseous carbon source, the injection flow rate of the gaseous carbon source is 0.5 L/min to 3 L/min, in some embodiments, the injection flow rate of the gaseous carbon source can be, for example, 0.5 L/min, 1 L/min, 1.5 L/min, 2 L/min, 2.5 L/min and 3 L/min, or the like, and can also be other values within the above range, which is not limited herein.

In some embodiments, when the carbon source is a gaseous carbon source, the temperature of the second heat treatment ranges from 500° C. to 1000° C., and the temperature of the second heat treatment can be, for example, 500° C., 600° C., 700° C., 800° C., 900° C. or 1000° C., or the like, and can also be other values within the above range, which is not limited herein.

In some embodiments, when the carbon source is a gaseous carbon source, the heat preservation time of the second heat treatment ranges from 0.5 h to 5 h, in some embodiments, the heat preservation time of the first heat treatment can be, for example, 0.5 h, 1 h, 2 h, 3 h, 4 h and 5 h, or the like, and can also be other values within the above range, which is not limited herein.

In some embodiments, when the carbon source is a solid carbon source, the mass ratio of the first precursor to the carbon source is 1:(0.01 to 0.1), for example, the mass ratio of the first precursor to the carbon source can be 1:0.01, 1:0.05, 1:0.1, 1:0.5, 1:0.8 or 1:0.1, or the like, and can also be other values within the above range, which is not limited herein.

In some embodiments, when the carbon source is a solid carbon source, the temperature of the second heat treatment ranges from 400° C. to 800° C., and the temperature of the second heat treatment can be, for example, 400° C., 500° C., 600° C., 700° C. or 800° C., or the like, and can also be other values within the above range, which is not limited herein.

In some embodiments, when the carbon source is a solid carbon source, the heat preservation time of the second heat treatment ranges from 0.5 h to 10 h, in some embodiments, the heat preservation time of the first heat treatment can be, for example, 0.5 h, 1 h, 2 h, 3 h, 4 h, 5 h, 6 h, 7 h, 8 h, 9 h or 10 h, or the like, and can also be other values within the above range, which is not limited herein.

In some embodiments, when the carbon source is a solid carbon source, the second heat treatment is performed in a second protective atmosphere, the second protective atmosphere includes at least one of nitrogen, helium, and argon.

In some embodiments, the heating rate of the second heat treatment ranges from 1° C./min to 10° C./min, for example, the heating rate of the second heat treatment can be, for example, 1° C./min, 2° C./min, 3° C./min, 5° C./min, 8° C./min or 10° C./min, or the like, and can also be other values within the above range, which is not limited herein.

In some embodiments, the preparation method of the present disclosure further includes: after the second heat treatment, the method further includes a step of washing and drying the material obtained by the second heat treatment with water. Excess water-soluble salt in the material is removed through washing with water, so that the ratio of silicon to oxygen in the material is increased, and the capacity of the anode material is improved.

In some embodiments, before the washing with water, the method further includes: a step of soaking and filtering the material obtained by the second heat treatment in water to fully dissolve the salt and washing the filtered solid with water.

In some embodiments, the soaking time ranges from 10 min to 60 min, in some embodiments, the soaking time can be, for example, 10 min, 20 min, 30 min, 40 min, 50 min or 60 min, or the like, and can also be other values within the above range, which is not limited herein.

In some embodiments, the soaking is performed under the stirring condition at a stirring speed of 100 r/min to 500 r/min, in some embodiments, the stirring speed can be, for example, 100 r/min, 150 r/min, 200 r/min, 250 r/min, 300 r/min, 350 r/min, 400 r/min or 500 r/min, or the like, and can also be other values within the above range, which is not limited herein.

In some embodiments, the soaking temperature ranges from 25° C. to 80° C., in some embodiments, the soaking temperature is 25° C., 30° C., 40° C., 50° C., 60° C., 70° C. or 80° C., or the like, and can also be other values within the above range, which is not limited herein.

In some embodiments, the water washing time ranges from 30 min to 90 min, in some embodiments, the water washing time can be, for example, 30 min, 40 min, 50 min, 60 min, 70 min, 80 min, 90 min, or the like, and can also be other values within the above range, which is not limited herein.

In some embodiments, the flow rate of the water washing ranges from 5 L/min to 20 L/min, in some embodiments, the flow rate of the water washing is 5 L/min, 10 L/min, 15 L/min, 20 L/min, or the like, and can also be other values within the above range, which is not limited herein.

In summary, in the present disclosure, a salt substance and a metal source are added in the process for preparing the anode material, so that the core and/or the carbon material can be catalyzed to grow a fibrous substance. Under a molten salt system formed by the salt substance, the metal source can catalyze the core to generate silicon fiber by using the metal source, and the silicon fiber is radially distributed inside the core and the coating layer and mainly distributed on the surface of the anode material. The carbon material can also be catalyzed to generate the carbon fiber under a molten salt system formed by the salt substance, and the carbon fiber is distributed inside and on the surface of the coating layer.

The present disclosure also provides a lithium ion battery including an anode material as described above.

The present disclosure will be further described by using following examples.

### Example 1

(1) 900 g of silicon monoxide, 80 g of lithium hydride, 7.5 g of lithium fluoride, 7.5 g of lithium carbonate and 5 g of lithium phosphate were weighed, and were dry-mixed in a reactor for 30 min under the protection of argon, in which the stirring speed was 500 r/min.
(2) The material mixed in step (1) was transferred into a high-pressure reactor, heated to 650° C. at 10° C./min in the argon atmosphere, reacted for 10 h, and the pressure in the reactor was maintained at normal pressure (about 0.1 MPa).
(3) A carbon coating layer was prepared from the material obtained in step (2) by chemical vapor deposition, and a preparation process was as follows: the carbon source was methane, the inlet gas flow rate of methane is 2 L/min, the temperature was 800° C., and the deposition time was 0.5 h.
(4) The material obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

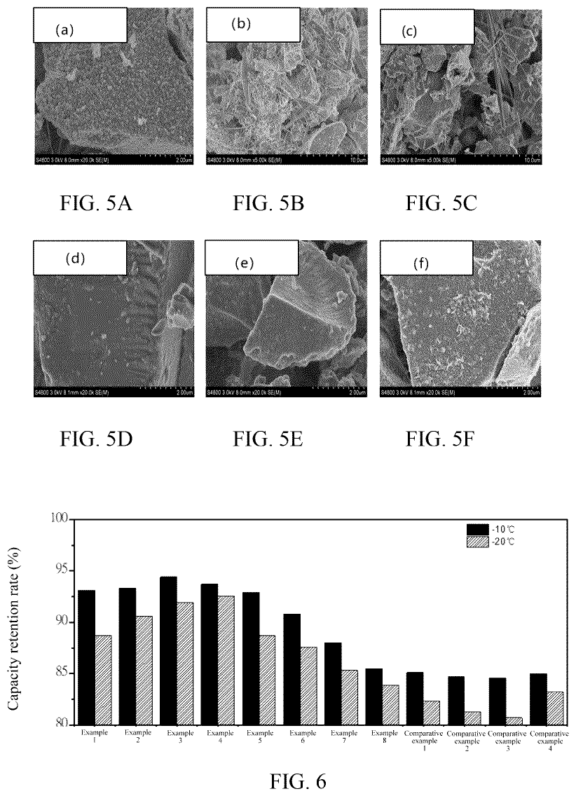

The SEM image of the anode material prepared in this example is shown in FIG. 5 (a), and the anode material prepared in this example includes silicon monoxide, a salt coating layer and a carbon layer which sequentially coat the surface of the silicon monoxide. The material of the salt coating layer is a solid solution deposit of lithium fluoride, lithium carbonate and lithium phosphate. The surface of the carbon layer is distributed with carbon fiber, silicon fiber and silicate fiber, mainly carbon fiber.

### Example 2

(1) 900 g of silicon monoxide, 80 g of metal aluminum powder, 5 g of lithium fluoride, 5 g of lithium carbonate, 5 g of aluminum fluoride and 5 g of aluminum carbonate were weighed, and were dry-mixed in a reactor for 30 min under the protection of argon, and the stirring speed was 500 r/min.
(2) The pre-material mixed in step (1) was transferred into a high-pressure reactor, heated to 900° C. at 10° C./min in the argon atmosphere, reacted for 10 h, and the pressure in the reactor was maintained at normal pressure (about 0.2 MPa).
(3) The sintered product obtained in step (2) was prepared into a carbon coating layer by chemical vapor deposition, and a preparation process was as follows: the carbon source was methane, the inlet gas flow rate of methane is 2 L/min, the temperature was 800° C., and the deposition time was 0.5 h.
(4) The coated product obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

An SEM image of the anode material prepared in this example is shown in FIG. 5 (b), and the anode material prepared in this example includes a silicon monoxide, a salt substance coated on a surface of the silicon monoxide, and a composite coating layer of amorphous carbon. The salt substance is a eutectic deposit of lithium fluoride, aluminum fluoride, lithium carbonate, and aluminum carbonate. As shown in FIG. 5 (b), the surface of the composite coating layer is distributed with carbon fiber, silicon fiber and silicate fiber, mainly silicon fiber.

### Example 3

(1) 900 g of silicon monoxide, 80 g of metal magnesium powder, 5 g of lithium fluoride, 5 g of lithium carbonate, 5 g of magnesium fluoride and 5 g of magnesium carbonate were weighed, and were dry-mixed in a reactor for 30 min under the protection of argon, and the stirring speed was 500 r/min.
(2) The material mixed in step (1) was transferred into a high-pressure reactor, heated to 800° C. at 10° C./min in the argon atmosphere, reacted for 10 h, and the pressure in the reactor was maintained at normal pressure (about 0.15 MPa).
(3) The sintered product obtained in step (3) was prepared into a carbon coating layer by chemical vapor deposition, and a preparation process was as follows: the carbon source was methane, the inlet gas flow rate of methane is 2 L/min, the temperature was 800° C., and the deposition time was 0.5 h.
(4) The sintered product obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

An SEM image of the anode material prepared in this example is shown in FIG. 5 (c), and the anode material prepared in this example includes a silicon monoxide, a salt substance coated on a surface of the silicon monoxide, and a composite coating layer of amorphous carbon. The salt substance is a solid solution deposit of lithium fluoride, magnesium fluoride, lithium carbonate, and magnesium carbonate. As shown in FIG. 5 (c), the surface of the composite coating layer is distributed with carbon fiber, silicon fiber and silicate fiber, mainly silicate fiber (magnesium silicate and lithium silicate).

### Example 4

(1) 900 g of silicon monoxide, 40 g of metal lithium, 40 g of metal aluminum, 5 g of lithium fluoride, 5 g of lithium titanate, 5 g of aluminum fluoride and 5 g of aluminum carbonate were weighed, and were dry-mixed in a reactor for 30 min under the protection of argon, and the stirring speed was 500 r/min.
(2) The material mixed in step (1) was transferred into a high-pressure reactor, heated to 1000° C. at 10° C./min in the argon atmosphere, reacted for 10 h, and the pressure in the reactor was maintained at normal pressure (about 0.1 MPa).
(3) The sintered product obtained in step (2) was prepared into a carbon coating layer by chemical vapor deposition, and a preparation process was as follows: the carbon source was methane, the inlet gas flow rate of methane is 2 L/min, the temperature was 800° C., and the deposition time was 0.5 h.
(4) The sintered product obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

In the anode material prepared in this example, the anode material includes a silicon monoxide, a salt coating layer and a carbon layer that sequentially coat the silicon monoxide, and the salt coating material is a solid solution deposit of lithium fluoride, aluminum fluoride, lithium titanate, and aluminum carbonate. The surface of the carbon layer is distributed with carbon fiber, silicon fiber and silicate fiber, mainly silicon fiber.

### Example 5

Different from Example 1, the salt substance “7.5 g lithium fluoride, 7.5 g lithium carbonate and 5 g lithium phosphate” in step (1) was replaced with “5 g lithium titanate, 5 g lithium carbonate, 5 g lithium phosphate and 5 g lithium nitrate”.

In the anode material prepared in this example, the anode material includes a silicon monoxide core to coat a carbon layer on the surface of the silicon monoxide, the molten salt is washed and removed in step (4). The surface of the carbon layer is distributed with carbon fiber, silicon fiber and silicate fiber, mainly carbon fiber.

### Example 6

(1) 900 g of silicon monoxide, 80 g of lithium hydride, 10 g of lithium fluoride and 10 g of lithium carbonate were weighed, and were dry-mixed in a reactor under the protection of argon for 30 min at a stirring speed of 500 r/min.
(2) The material mixed in step (1) was transferred into a high-pressure reactor, heated to 650° C. at 10° C./min in the argon atmosphere, reacted for 10 h, and the pressure in the reactor was maintained at normal pressure (about 0.1 MPa).
(3) The carbon coating layer was prepared from the material obtained in step (2) by chemical vapor deposition, and a preparation process was as follows: the carbon source was methane, the inlet gas flow rate of methane is 2 L/min, the temperature was 800° C., and the deposition time was 0.5 h.
(4) The material obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

The anode material prepared in this example includes silicon monoxide, and a salt coating layer and a carbon layer which sequentially coat the silicon oxide. The material of the salt coating layer is a solid solution deposit of lithium fluoride and lithium carbonate. The surface of the carbon layer is distributed with carbon fiber, silicon fiber and silicate fiber, mainly carbon fiber.

### Example 7

(1) 900 g of silicon monoxide, 80 g of aluminum powder, 7.5 g of lithium fluoride, 7.5 g of lithium carbonate and 5 g of lithium phosphate were weighed, and were dry-mixed in a reactor for 30 min under the protection of argon, and the stirring speed was 500 r/min.
(2) The material mixed in step (1) was transferred into a high-pressure reactor, heated to 650° C. at 10° C./min in the argon atmosphere, reacted for 10 h, and the gas pressure in the reactor was maintained at normal pressure (about 0.1 MPa).
(3) The sintered product obtained in step (2) was prepared into a carbon coating layer by chemical vapor deposition, and a preparation process was as follows: the carbon source was methane, the inlet gas flow rate of methane is 2 L/min, the temperature was 800° C., and the deposition time was 0.5 h, the anode material was obtained.
(4) The sintered product obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed.

In the anode material prepared in this example, the anode material includes a silicon monoxide, a salt substance coated on a surface of the silicon monoxide, and a composite coating layer of amorphous carbon, the salt substance is a solid solution deposit of lithium fluoride, lithium carbonate, and lithium phosphate. A surface of the composite coating layer is distributed with carbon fiber, silicon fiber, and silicate fiber, mainly silicon fiber and silicate fiber.

### Example 8

(1) 980 g of silicon monoxide, 7.5 g of lithium fluoride, 7.5 g of lithium carbonate and 5 g of lithium phosphate were weighed, and were dry-mixed in a reactor for 30 min under the protection of argon, in which the stirring speed was 500 r/min.
(2) The material mixed in step (1) was transferred into a high-pressure reactor, heated to 650° C. at 10° C./min in an argon atmosphere, reacted for 10 h, the gas pressure in the reactor was maintained at 10 MPa.
(3) The sintered product obtained in step (2) was prepared into a carbon coating layer by chemical vapor deposition, and a preparation process was as follows: the carbon source was methane, the inlet gas flow rate of methane is 2 L/min, the temperature was 800° C., and the deposition time was 0.5 h.
(4) The sintered product obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

In the anode material prepared in this example, the anode material includes silicon monoxide, a salt coating layer and a carbon layer that sequentially coat the silicon monoxide, the salt coating layer is made of a solid solution deposit of lithium fluoride, lithium carbonate, and lithium phosphate. The surface of the carbon layer is distributed with carbon fiber.

### Comparative Example 1

900 g of silicon monoxide was weighed to prepare a carbon coating layer by chemical vapor deposition, and the preparation process is as follows: the carbon source was methane, the inlet gas flow rate of methane is 2 L/min, the temperature was 800° C., and the deposition time was 0.5 h, the anode material was obtained.

The anode material prepared in the Comparative Example includes a silicon monoxide core and a carbon layer coated on the surface of the silicon monoxide, the carbon layer is smooth, and the SEM image of the anode material is shown in FIG. 5 (d), indicating that the anode material prepared in this Comparative Example does not contain a fiber material.

### Comparative Example 2

(1) 900 g of silicon monoxide and 80 g of lithium hydride were weighed, the above materials were dry-mixed in a reactor for 30 min under the protection of argon at a stirring speed at 500 r/min.
(2) The material mixed in step (1) was transferred into a high-pressure reactor, heated to 650° C. at 10° C./min in an argon atmosphere, reacted for 10 h. The reactor was sealed, and the internal pressure was maintained at normal pressure (about 0.1 MPa).
(3) The sintered product obtained in step (3) was prepared into a carbon coating layer by chemical vapor deposition, and a preparation process was as follows: the carbon source was methane, the inlet gas flow rate of methane is 2 L/min, the temperature was 800° C., and the deposition time was 0.5 h.
(4) The sintered product obtained in step (3) was immersed in 5 kg deionized water, stirred in a water bath at a rate of 200 r/min at 80° C. for 1 h, and then transferred to a centrifuge for a centrifugal water washing time of 30 min, a flow rate of deionized water in the water washing was 20 L/min, and after the water washing was completed, centrifugation was continued for 120 min; after the centrifugation was completed, drying was performed to obtain an anode material.

The anode material prepared in the Comparative Example includes a silicon monoxide core and a carbon layer coated on the surface of the silicon monoxide, the carbon layer is smooth, and the SEM image of the anode material is shown in FIG. 5 (e), indicating that the anode material prepared in the Comparative Example does not contain a fiber material.

### Comparative Example 3

Different from Example 1, step (3) was not performed.

The anode material prepared in the Comparative Example includes a silicon monoxide core and a coating layer coated on a surface of the silicon monoxide, and a material of the coating layer is a solid solution deposit of lithium fluoride, lithium carbonate, and lithium phosphate. The SEM image of the anode material is shown in FIG. 5 (f), the surface of the coating layer is distributed with a small amount of fiber material, and the fiber material is mainly silicon fiber.

### Comparative Example 4

Different from Example 1, the salt substance “7.5 g lithium fluoride, 7.5 g lithium carbonate and 5 g lithium phosphate” in step (1) was replaced with “20 g lithium carbonate”.

Step (2): the pre-material mixed in step (1) was transferred into a high-pressure reactor, heated to 1000° C. at 10° C./min in an argon atmosphere, reacted for 10 h, and the pressure in the sealed reactor was freely increased.

### Performance Test

(1) The specific capacity and the first charge and discharge coulombic efficiency of the anode material were according to BTRTC/ZY/01-020 “Button Battery Method Operation Guide book” equipment and method: a button battery was assembled, a metal lithium sheet was used as the counter electrode, the separator was a PP-PE-PP composite membrane with a diameter of 19.2 mm; the electrolyte composition ratio was EC/EMC/DMC=1/1/1, the lithium salt (LiPF 6) concentration was 1.05 mol/L. The test method was as follows: the button battery charging and discharging device was used, the 0.1C constant current was charged to 10 mV to 0.02C constant current was charged to 5 mV, 0.1C constant current was discharged to 1.5V cut-off.
(2) Full battery Fabrication: lithium cobalt oxide was used as the positive electrode, and the anode materials of Examples 1 to 8 and Comparative Examples 1 to 4 were used as the anode of the lithium-ion battery, respectively, the electrolyte was 1 mol/L LiPF₆/EC+PC+December+EMC (volume ratio of 1:0.3:1:1), the separator was a PP/PE/PP three-layer separator with a thickness of 16 μm, and a soft package battery with a thickness of about 3 Ah was manufactured for testing the full battery performance of the material.
(3) Half-Battery 50 Cycles Test: the button battery charging and discharging device was used, cycle 1, 0.1C discharged to 0.01V, discharged by decreasing with a tolerance of 0.01C to 0.01V, 0.01C discharged to 0.005V, 0.1C charged to 1.5V; cycle 2, 0.2C discharged to 0.01V, decreasing discharged by decreasing with a tolerance of 0.02C to 0.01V, 0.02C discharged to 0.005V, 0.2C charged to 1.5V; cycle 3, 0.5C discharged to 0.01V, discharged by decreasing with a tolerance of 0.05C to 0.01V, 0.05C discharged to 0.005V, and 0.5C charged to 1.5V; cycle 4 to cycle 50, 1C discharged to 0.01V, discharged by decreasing with a tolerance of 0.1C to 0.01V, 0.1C discharged to 0.005V, and 1C charged to 1.5V; cycle 51, 0.1C discharged to 0.01V, discharged by decreasing with a tolerance of 0.01C to 0.01V, 0.01C discharged to 0.005V.
(4) Full battery Rate Performance Test: under a working voltage of 2.75 to 4.2V, a charge and discharge capacity of 0.5C was performed, a charge/discharge capacity of 3C/0.5C was performed, a capacity comparison was performed, and a capacity retention rate of 3C/0.5C was measured.
(5) Full Battery Low Temperature Performance Test: the low temperature (−10° C. and −20° C.) capacity retention test was 0.2C charged, (2.75 to 4.2V).
(6) The thickness of the coating layer of the anode material was tested by SEM electron microscopy.
(7) The fiber diameter was measured by “GB/T268260-2011 measurement method of carbon nanotube diameter” using a fluoroscopic electron microscope and a scanning electron microscope, and the lower limit value of the fiber diameter of the test result was selected as the minimum fiber diameter.
(8) The doping elements and their contents in the core and coating layer was tested by the ICP method. About 0.5 g of a battery silicon-based material sample was weighed in a platinum crucible and burned at 750° C. for 2 h until the carbon element is completely burned, then 4 mL of HNO3 and 6 mL of HF were added, after the mixed acid was reacted with the sample stably, the platinum crucible was put on a 350° C. electric heating plate to heat the acid until hydrofluoric acid volatilized without white smoke, the crucible was cooled, then 6 mL of HCl was added, heated until the residue was completely dissolved, the volume is finally constant to 100 mL of plastic volumetric flask, and all contents are tested by using an ICP spectrometer.
(9) Powder Conductivity Test: a full-automatic powder resistivity test system is adopted to test the conductivity of a sample; and the test value is a conductivity value under 20 KN of the sample pressure.
(10) Particle Size Test: the median particle size and D₁₀ of the material were tested using a laser particle sizer.

The test results are shown in Table 1 and Table 2.

TABLE 1
Test result I of the parameters of the anode materials of each example and comparative examples

| | | | | | Thickness | Thickness | | |
|---|---|---|---|---|---|---|---|---|
| | Minimum | Powder | D₁₀ | | (μm) | (μm) | | Ratio of |
| | Diameter | Conductivity | (Nm) of | | of The | of The | Porosity | Silicon to |
| | (nm) | (S/m) of | The | | First | Second | (%) of the | Oxygen in |
| | of Fiber | Anode | Anode | | Coating | Coating | Anode | Anode |
| Sample | Material | Material | Material | ΔJ Value | Layer | Layer | Material | Material |
| Example | 20 | 0.833 | 1920 | 0.008 | 0.52 | 0.25 | 11.9 | 2 |
| 1 | | | | | | | | |
| Example | 113 | 0.914 | 1760 | 0.043 | 0.65 | / | 11.3 | 1.8 |
| 2 | | | | | | | | |
| Example | 285 | 0.794 | 1480 | 0.129 | 0.78 | / | 10.8 | 1.7 |
| 3 | | | | | | | | |
| Example | 132 | 0.815 | 1820 | 0.058 | 0.55 | 0.30 | 10.2 | 1.3 |
| 4 | | | | | | | | |
| Example | 17 | 1.021 | 1920 | 0.005 | 0.62 | / | 4.5 | 1.5 |
| 5 | | | | | | | | |
| Example | 25 | 0.830 | 1905 | 0.010 | 0.49 | 0.23 | 11.0 | 1.7 |
| 6 | | | | | | | | |
| Example | 312.54 | 0.763 | 1820 | 0.150 | 0.51 | / | 9.4 | 1.4 |
| 7 | | | | | | | | |
| Example | 19 | 0.988 | 1880 | 0.006 | 0.76 | 0.28 | 10.9 | 1.5 |
| 8 | | | | | | | | |
| Comparative | / | / | / | / | / | / | 5.5 | 1.2 |
| Example | | | | | | | | |
| 1 | | | | | | | | |
| Comparative | / | / | / | / | / | / | 5.7 | 1.3 |
| Example | | | | | | | | |
| 2 | | | | | | | | |
| Comparative | 121.0 | 0.012 | 2200 | 5.50 | 0.65 | / | 8.4 | 1.2 |
| Example | | | | | | | | |
| 3 | | | | | | | | |
| Comparative | 73 | 0.051 | 1900 | 0.767 | 0.40 | / | 5.1 | 1.6 |
| Example | | | | | | | | |
| 4 | | | | | | | | |

TABLE 2
Test result II of the performance of the anode materials of each example and comparative examples.

| | | | | | Low- | Low- |
|---|---|---|---|---|---|---|
| | | | Capacity | | Temperature | Temperature |
| | | | Retention Rate | 3 C/0.5 C | Capacity | Capacity |
| | Capacity | First | after 50 cycles | Capacity | Retention Rate | Retention Rate |
| Sample | mAh/g | Efficiency (%) | (%) | Retention (%) | (−10° C.) | (−20° C.) |
| Example 1 | 1421.8 | 87.3% | 87.2% | 69.1% | 93.1% | 88.7% |
| Example 2 | 1401.2 | 85.2% | 88.3% | 70.2% | 93.3% | 90.6% |
| Example 3 | 1389.0 | 84.9% | 88.4% | 70.9% | 94.4% | 91.9% |
| Example 4 | 1409.7 | 86.3% | 90.3% | 72.3% | 93.7% | 92.5% |
| Example 5 | 1433.4 | 86.9% | 87.5% | 68.8% | 92.9% | 88.7% |
| Example 6 | 1422.7 | 84.3% | 89.5% | 70.9% | 90.8% | 87.6% |
| Example 7 | 1372.5 | 85.1% | 86.0% | 62.1% | 88% | 85.3% |
| Example 8 | 1468.4 | 82.5% | 84.7% | 61.2% | 85.5% | 83.9% |
| Comparative | 1537.2 | 75.2% | 82.3% | 54.2% | 85.1% | 82.3% |
| Example 1 | | | | | | |
| Comparative | 1411.9 | 84.3% | 80.7% | 51.7% | 84.7% | 81.3% |
| Example 2 | | | | | | |
| Comparative | 1149.2 | 74.6% | 80.9% | 51.1% | 84.6% | 80.7% |
| Example 3 | | | | | | |
| Comparative | 1202.9 | 88.0% | 83.3% | 58.2% | 85.0% | 83.2% |
| Example 4 | | | | | | |

As shown in Table 1 and Table 2, the anode material prepared in Examples 1 to 8 of the present disclosure includes a core and a coating layer at least coating the surface of the core, at least part of the surface of the coating layer is distributed with a fiber material, and due to the presence of the fiber material on the surface of the material, and the fiber and the anode material satisfy the formula (I), it indicates that the fiber material 4 of the anode material grows well in the radial direction. The fiber material 4 growing well in the radial direction can effectively reduce the load transfer impedance caused by lithium intercalation, improve the mass transfer efficiency, form a fast lithium intercalation channel, facilitate the in-situ conduction of the material and the lithium source, reduce the interface obstruction, improve the lithium conduction capability of the anode material, enable the anode material to quickly receive electrons and lithium ions, improve the conductivity of the anode material, and improve the rate performance of the anode material. Further, the anode material is of a core-shell structure, the carbon material is used as a coating layer, the conductive contact area of the material can be improved, and the rate performance of the anode material is further improved.

In FIG. 5, FIG. 5 (a), FIG. 5 (b), FIG. 5 (c), FIG. 5 (d), FIG. 5 (e) and FIG. 5 (f) are surface SEM images of Example 1, Example 2, Example 3, Comparative Example 1, Comparative Example 2 and Comparative Example 3 in sequence. According to the comparison of SEM images of Example 1, Example 2, Example 3 in FIG. 5, it can be found that the minimum diameter of the fiber material becomes larger and larger, mainly due to the selection difference of metal sources and the selection difference of silicate, the fiber material in Example 1 is mainly carbon fiber, the fiber material in Example 2 and Example 3 includes carbon fiber, silicon fiber and silicate fiber. It can be seen from the comparison of Example 1, Example 2, Example 3 that different metal sources and salt environments can result in differences in the morphology of the produced fibers. In contrast, the surface SEM images of Comparative Examples 1 and 2 in FIG. 5 show that the surface of the anode material is smooth and grows no fiber, and the surface SEM image of Comparative Example 3 shows that the surface of the anode material is rough and grows fiber having a small size.

The anode material prepared in Example 5, in a molten salt system without salt deposition, can still show high mass transfer and load transfer performance through carbon fiber-carbon coating-core.

FIG. 6 is a comparison diagram of the low-temperature capacity test performance of the anode materials of Examples 1 to 8 and Comparative Examples 1 to 4. It can be found that the low-temperature capacity retention rates of the anode materials of Examples 1, 2, 3, 4 and 5 having a fiber material structure are generally higher than those of the anode materials of other Examples and Comparative Examples, indicating that the structure of the combination of the fiber material with the core can improve the low-temperature performance and the rate performance of the anode material, because the nanofiber of the material can construct a fast mass transfer and load transfer channel, which can effectively alleviate the load transfer impedance caused by low powder conductivity, improve the mass transfer efficiency, improve the inter-interface load transfer resistance, and improve the low-temperature performance of the anode material. In addition, the anode material containing the fiber material has a wide mass transfer and load transfer area and high extensibility, and can effectively combine the battery conductive network, thereby improving the cycle performance of the anode material.

In the anode material prepared in Comparative Example 3, although the surface of the material is distributed with the fiber material, the surface of the material lacks a coating layer, resulting in performance deterioration of the anode material.

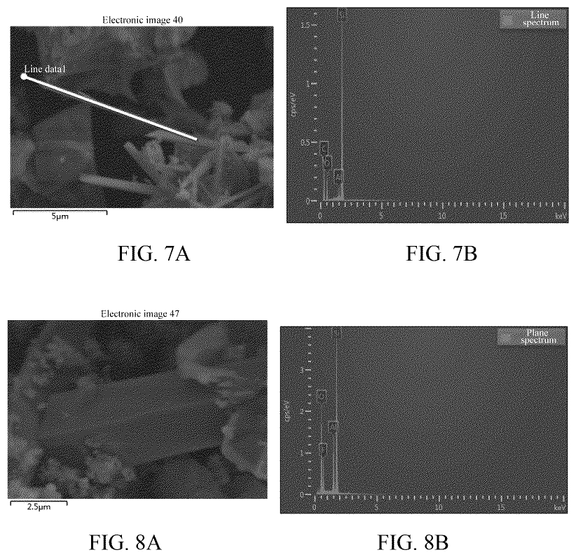

As shown in FIG. 7 and FIG. 8, FIG. 7 is a fiber EDS diagram of an anode material prepared in Example 2 of the present disclosure, and FIG. 8 is a fiber EDS diagram of an anode material prepared in Comparative Example 4 of the present disclosure. In Example 2, the fiber is mainly made of fiber material, while in Comparative Example 4, the silicon fiber and the silicate fiber are mainly made of silicon fiber and silicate fiber, and in Comparative Example 4, due to different doping sources, the treatment temperature is increased, resulting in the fiber being thickened, so that the influence relation value ΔJ of the fiber diameter, the particle size of the anode material and the conductivity doesn't satisfy the relation (I) disclosed in the present disclosure, thereby deteriorating material performance. It can be seen from the comparison between Example 2 and Comparative Example 4 that the molten salt system with a proper surface can effectively reduce the treatment temperature, which is beneficial to nanowire pipe diameter generation, and reduces block generation.

It can be seen from Table 2 that, compared with a conventional anode material with a charging capacity of about 0.5C at normal temperature, the anode active material of the lithium ion battery provided by the examples of the present disclosure can satisfy daily requirements under the condition of 3C rapid charging at normal temperature, and can maintain good performance at low temperature.

The above are merely exemplary embodiments of the present disclosure, which, as mentioned above, are not used to limit the present disclosure. For those skilled in the art, the present disclosure can be subject to various modifications and changes. Whatever within the principles of the present disclosure, including any modification, equivalent substitution, improvement, etc., shall fall into the protection scope of the present disclosure.

What is claimed is:

1. An anode material, comprising:
a core; and
a first coating layer at least partially coating on a surface of the core, wherein the core comprises a silicon-based material, the first coating layer comprises a carbon material, and at least a part of a surface of the first coating layer is distributed with a fiber material; and
the fiber material and the anode material satisfy a formula (I):
$$\frac{{D}_{w i r e}}{{D}_{10}} \times \frac{1}{exp ( ρ ) - 1} \leq 0.15 \qquad ( I )$$
wherein D_{wire} represents a minimum fiber diameter (nm) of the fiber material, D₁₀ represents a corresponding particle size (nm) when the cumulative particle size distribution number of the anode material reaches 10%, and ρ represents a powder conductivity (S/cm) of the anode material.

2. The anode material according to claim 1, comprising at least one of:
a fiber diameter of the fiber material ranges from 2 nm to 200 nm; or
interior of the first coating layer is distributed with the fiber material.

3. The anode material according to claim 1, comprising at least one of:
the fiber material comprises at least one of carbon fiber and silicon fiber; or
the fiber material comprises at least one of carbon fiber and silicon fiber, and the carbon fiber comprises at least one of carbon fiber, carbon nanotube and polymer fiber.

4. The anode material according to claim 1, comprising at least one of:
the fiber material includes at least one of carbon fiber and silicon fiber, and the silicon fiber comprises at least one of silicon fiber and silicate fiber;
the fiber material comprises at least one of carbon fiber and silicon fiber, the carbon fiber comprises at least one of carbon fiber, carbon nanotube and polymer fiber, and the polymer fiber comprises at least one of polypropylene fiber, polyester fiber, polyamide fiber, polyacrylic fiber, polymerase fiber and polyamine fiber; or
the carbon material comprises at least one of amorphous carbon, graphite, graphene, and diamond-like carbon.

5. The anode material according to claim 1, comprising at least one of:
the first coating layer further comprises a salt substance and the salt substance comprises an inorganic salt and an organic salt; or
the first coating layer further comprises a salt substance, the salt substance comprises an inorganic salt and an organic salt, and the inorganic salt comprises at least one of fluoride, lithium salt, carbonate, silicate, phosphate, nitrate, titanate, thioate and vanadate.

6. The anode material according to claim 1, comprising at least one of:
the first coating layer further comprises a salt substance, the salt substance comprises an inorganic salt and an organic salt, and the organic salt comprises at least one of a carboxylate, an alkoxide, and an aromatic salt compound; or
the first coating layer further comprises a salt substance, and a thickness of the first coating layer ranges from 0.1 μm to 1.2 μm.

7. The anode material according to claim 1, comprising at least one of:
a thickness of the first coating layer ranges from 0.01 μm to 1 μm; or
the first coating layer contains a first doping element, and the first doping element comprises at least one of N, P, B, S, O, F, Cl, Br, and I.

8. The anode material according to claim 1, comprising at least one of:
the first coating layer contains a first doping element, and a mass ratio of the first doping element in the first coating layer ranges from 0.01% to 5%; or
the core comprises at least one of crystalline silicon and silicide.

9. The anode material according to claim 1, comprising at least one of:
the core comprises at least one of crystalline silicon and a silicide, the silicide comprises at least one of silicate, silicon oxide, silicon phosphide, silicon carbide, silicon nitride, and silicon alloy; or
a mass ratio of the metal element in the core ranges from 0 to 15%, and the metal element comprises at least one of lithium, sodium, magnesium, aluminum, copper, titanium, boron, beryllium, calcium, vanadium, chromium, lanthanum and selenium.

10. The anode material according to claim 1, further comprising at least a second coating layer disposed between the core and the first coating layer, or a second coating layer disposed on a region of the core surface that is not coated by the first coating layer.

11. The anode material according to claim 10, wherein the second coating layer comprises at least one of:
a salt substance, wherein the salt substance comprises an inorganic salt and an organic salt; or
a salt substance wherein the salt substance comprises an inorganic salt and an organic salt, and the inorganic salt comprises at least one of fluoride, lithium salt, carbonate, silicate, phosphate, nitrate, titanate, thioate and vanadate.

12. The anode material according to claim 10, wherein the second coating layer comprises at least one of:
a salt substance, wherein the salt substance comprises an inorganic salt and an organic salt, and the organic salt comprises at least one of a carboxylate, an alkoxide, and an aromatic salt compound;
a salt substance wherein the salt substance has a mass ratio of the salt substance in the anode material ranges from 0.01 wt % to 3.0 wt %; or
a thickness of the second coating layer ranging from 0 μm to 1 μm.

13. The anode material according to claim 1, comprising at least one of:
the anode material comprises a salt substance, and a mass ratio of the salt substance ranges from 0 wt % to 3.0 wt %; or
a mass ratio of the carbon element in the anode material ranges from 0.5 wt % to 10 wt %.

13. The anode material according to claim 1, comprising at least one of:
a median particle size D₅₀ of the anode material ranges from 2.0 μm to 10.0 μm; or
a particle size D₁₀ with a particle cumulative distribution of 10% in the anode material ranges from 0.5 μm to 4 μm.

14. The anode material according to claim 1, comprising at least one of:
a powder conductivity of the anode material ranges from 0.01 S/cm to 500 S/cm;
a ratio Si/O of silicon to oxygen in the anode material ranges from 0.5 to 3.0; or
a porosity of the anode material ranges from 0.5% to 15%.

15. A method for preparing an anode material, comprising:
performing a first heat treatment on a mixture containing a silicon-oxygen raw material and at least two salt substances to form a molten salt to obtain a first precursor; and
mixing the first precursor with a carbon source and then performing a second heat treatment to obtain an anode material.

16. The method according to claim 15, comprising at least one of:
the silicon-oxygen raw material comprises silicon oxide SiOₓ, where 0.05≤x≤2;
the salt substance comprises an inorganic salt and an organic salt;
the salt substance comprises an inorganic salt and an organic salt, and the inorganic salt comprises at least one of fluoride, lithium salt, carbonate, silicate, phosphate, nitrate, titanate, thioate and vanadate;
the salt substance comprises an inorganic salt and an organic salt, and the organic salt comprises at least one of a carboxylate, an alkoxide and an aromatic salt compound;
a mass ratio of the salt substance in the first precursor ranges from 1.0 wt % to 20 wt %;
a temperature of the first heat treatment ranges from 400° C. to 1200° C.;
a heat preservation time of the first heat treatment ranges from 3 h to 24 h;
a heating rate of the first heat treatment ranges from 1° C./min to 10° C./min;
a pressure of the first heat treatment ranges from 0.1 MPa to 20 MPa;
the first heat treatment is performed in a first protective atmosphere, the first protective atmosphere comprises at least one of nitrogen, helium, and argon;
a temperature of the second heat treatment ranges from 400° C. to 1000° C.;
a heat preservation time of the second heat treatment ranges from 0.5 h to 10 h; or
a heating rate of the second heat treatment ranges from 1° C./min to 10° C./min.

17. The method according to claim 15, comprising at least one of:
the carbon source comprises at least one of a solid carbon source and a gaseous carbon source;
the carbon source comprises at least one of a solid carbon source and a gaseous carbon source, and the solid carbon source comprises at least one of asphalt, epoxy resin and phenolic resin;
the carbon source comprises at least one of a solid carbon source and a gaseous carbon source, and the gaseous carbon source comprises at least one of methane, acetylene, ethylene and propane;
the carbon source includes a gaseous carbon source, and an injection flow rate of the gaseous carbon source ranges from 0.5 L/min to 3 L/min;
the carbon source comprises a solid carbon source, and a mass ratio of the first precursor to the carbon source is 1:(0.01 to 0.1); and
the carbon source comprises a solid carbon source, the second heat treatment is performed in a second protective atmosphere, the second protective atmosphere comprises at least one of nitrogen, helium, and argon.

18. The method according to claim 15, wherein after the second heat treatment, the method further comprises: washing and drying the material obtained by the second heat treatment with water; wherein the method comprises at least one of:
the water washing time ranges from 30 min to 90 min;
the water washing flow rate ranges from 5 L/min to 20 L/min;
the drying method comprises at least one of blast drying and vacuum drying;
the drying temperature ranges from 25° C. to 120° C.; or
the drying time ranges from 3 h to 48 h.

19. The method according to claim 18, wherein before washing the material obtained by the second heat treatment, soaking and filtering the material obtained by the second heat treatment in water; wherein the method comprises at least one of:
the soaking time ranges from 10 min to 60 min;
the soaking is performed under a stirring condition at a stirring speed of 100 r/min to 500 r/min; or
the soaking is performed under the stirring conditions, and the soaking temperature ranges from 25° C. to 80° C.

20. A lithium ion battery comprising an anode material according to claim 1.
